(19) United States
(12) Patent Application Publication
(10) Pub. No.: US 2016/0099140 A1
(43) Pub. Date: Apr. 7, 2016

(54) ADHESIVE-LESS ASSEMBLY FOR ELECTRONIC COMPACT FLUORESCENT LAMPS

(71) Applicant: GENERAL ELECTRIC COMPANY, Schenectady, NY (US)

(72) Inventors: József Fülöp, BudaPest (HU); László Bánkuti, BudaPest (HU); Jácint Gergely, BudaPest (HU); Loránd Lehel Tóth, BudaPest (HU); György Kövári, BudaPest (HU); Rita Csirmaz, BudaPest (HU)

(21) Appl. No.: 14/753,802

(22) Filed: Jun. 29, 2015

Related U.S. Application Data
(60) Provisional application No. 62/060,961, filed on Oct. 7, 2014.

(51) Int. Cl. H01J 61/36

(52) U.S. Cl. CPC H01J 61/363

(57) ABSTRACT

A collar includes two sections that join together in an adhesive-less manner to form an aperture, an arm with a distally-located pawl extending from a base of each section, a frame on the other section at a position corresponding to the arm, a lower clamp located on the sections, an upper clamp including a distally-located projection extending from the base surface, first and second flexible clamps located at opposing ends of the aperture. A gas discharge tube lighting assembly includes a discharge tube collar, a discharge tube having a stem assembly with a first portion fitting within the discharge tube and a second portion having a seal ring with a diameter greater than the discharge tube outer diameter, the collar and tube connected by adhesive-less mechanical forces exerted on the upper, lower, and first and second flexible clamps with the discharge tube located partially in the aperture.

### CLAIM OF PRIORITY

This patent application claims the benefit of priority, under 35 U.S.C. §119, of U.S. Provisional Patent Application Ser. No. 62/060,961, filed Oct. 7, 2014, titled “ADHESIVELESS ASSEMBLY FOR ELECTRONIC COMPACT FLUORESCENT LAMPS” the entire disclosure of which is incorporated herein by reference.

### BACKGROUND

A gas discharge tube lighting source includes electrodes and a gas (typically comprising a noble gas) within a glass envelope. Lighting sources that include gas discharge tubes include fluorescent, compact fluorescent, mercury, sodium, and high intensity discharge lamps. These lighting sources rely on an electric discharge between the electrodes to ionize the gas to create illumination.

A compact fluorescent lamp (CFL) is a fluorescent lamp typically shaped to replace an incandescent lamp using the same lamp socket as the incandescent lamp. An integrated CFL includes an electronic ballast in the base of the CFL to generate sufficient voltage to support arcing between the electrodes within the discharge tube; otherwise a ballast needs to be installed in the lighting fixture.

FIG. 1 depicts CFL discharge tube 110 which encloses a discharge volume filled with a discharge gas, where discharge tube ends 115a, 115b are sealed in a gas tight manner to form an arc path. Disposed internal to the discharge tube, and at respective tube ends, are electrodes. Protruding from each of discharge tube ends 115a, 115b are two lead-in wires 120. The lead-in wires are connected through the gas-tight seal at each end of the discharge tube to respective electrodes. Other light source technologies each have at least a pair of lead-in wires extending from the discharge tube.

Conventionally, the gas-tight seal of the discharge tube is accomplished by inserting a stem assembly into the open ends of the discharge tube. The stem assembly can include lead-in wires, an exhaust tube, and in some configurations a coil attached to the lead-in wires. The stem assembly can include a flare which has an outer diameter along its entire length that fits within the inner diameter of the discharge tube. The stem assembly is inserted into the discharge tube and positioned at a predetermined location. The seal between the discharge tube inner surface and the outer surface of the stem flare is secured using thermal bonding. The discharge tube edge and the stem flare can be heated in the range of about 800-1000° C. By heating the glass discharge tube and the glass stem flare the two parts join together.

### BRIEF DESCRIPTION OF THE DRAWINGS

FIG. 1 depicts a conventional CFL discharge tube;

FIG. 2 depicts a stem assembly in accordance with embodiments;

FIG. 3 depicts a portion of a gas discharge tube assembly in accordance with embodiments;

FIGS. 4A-4B depict a perspective view of a discharge tube collar sections in accordance with some embodiments;

FIG. 4C depicts a perspective view of a discharge tube collar assembled from the sections of FIGS. 4A-4B in accordance with some embodiments;

FIG. 5 depicts a perspective view of a discharge tube assembly in accordance with some embodiments; and

FIG. 6 depicts a partial perspective view of the discharge tube assembly of FIG. 5 in accordance with some embodiments.

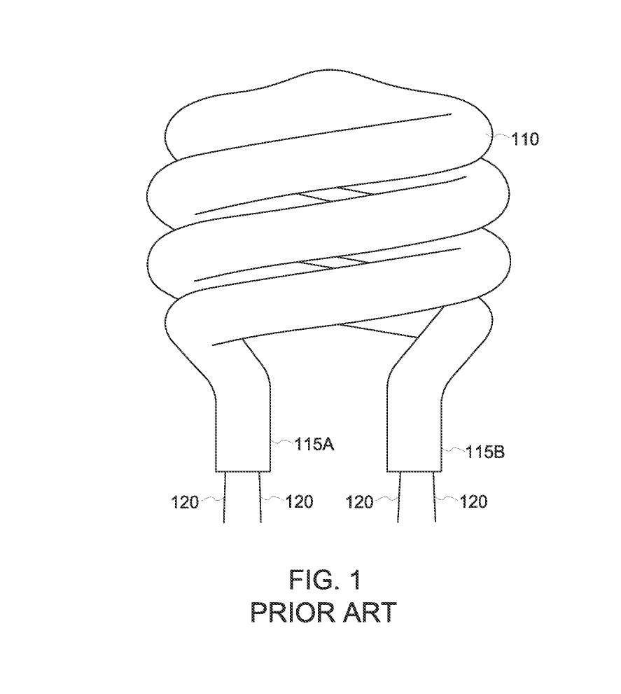

### DESCRIPTION

Devices and methods in accordance with embodiments provide a mechanical connection between a discharge tube and a collar. This mechanical connection is achieved without the use of adhesives. In accordance with embodiments, the collar clamps to a seal ring of the discharge tube.

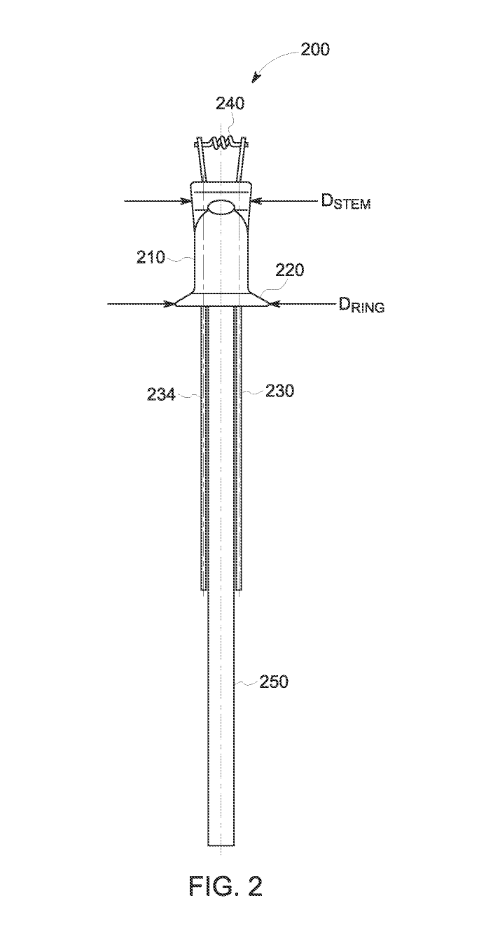

FIG. 2 depicts stem assembly 200 having tube portion 210 that includes a flare portion 220 in accordance with embodiments. In some implementations, tube portion 210 can be a glass tube, and/or a plastic tube. However embodying stem assemblies are not so limited, and other suitable materials can be used. The embodying stem assembly can include lead-in wires 230, 234, exhaust tube 250, and in some implementations coil 240 which is in electrical connection with the lead-in wires.

Tube portion 210 has a first portion that has a diameter Dₛₜₑₘ that is sized to be less than the discharge tube inner diameter. Flare 220 increases the diameter of tube portion 210 from the diameter Dₛₜₑₘ to a diameter D_{ring} which is greater than the outer diameter of the discharge tube end.

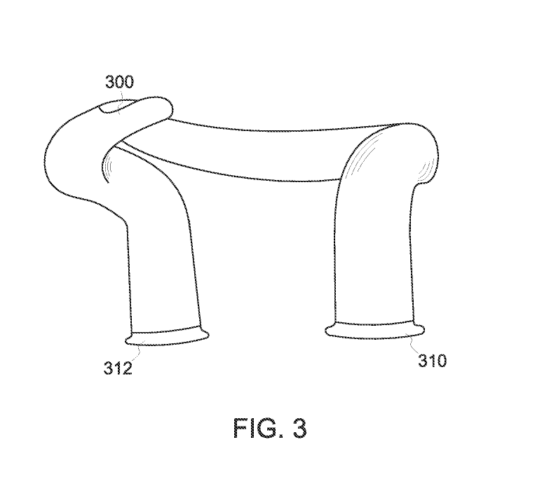

FIG. 3 depicts a portion of discharge tube 300 with stem assembly 200 inserted into the ends of the discharge tube in accordance with embodiments. The flare of the stem assembly is depicted as melted and pressed together with an end of the discharge tube to create a seal. The flare has an overall diameter D_{ring} that is greater than the discharge tube outer diameter Dₒᵤₜₑᵣ. Seal rings 310, 312 protrude from the discharge tube end(s). An embodying discharge tube collar is sized to fit over the seal ring and around the discharge tube to form a seal by mechanical forces that clamp and hold the discharge tube and the discharge tube collar together free from the use of adhesives and/or thermal bonding (i.e., curing by heat).

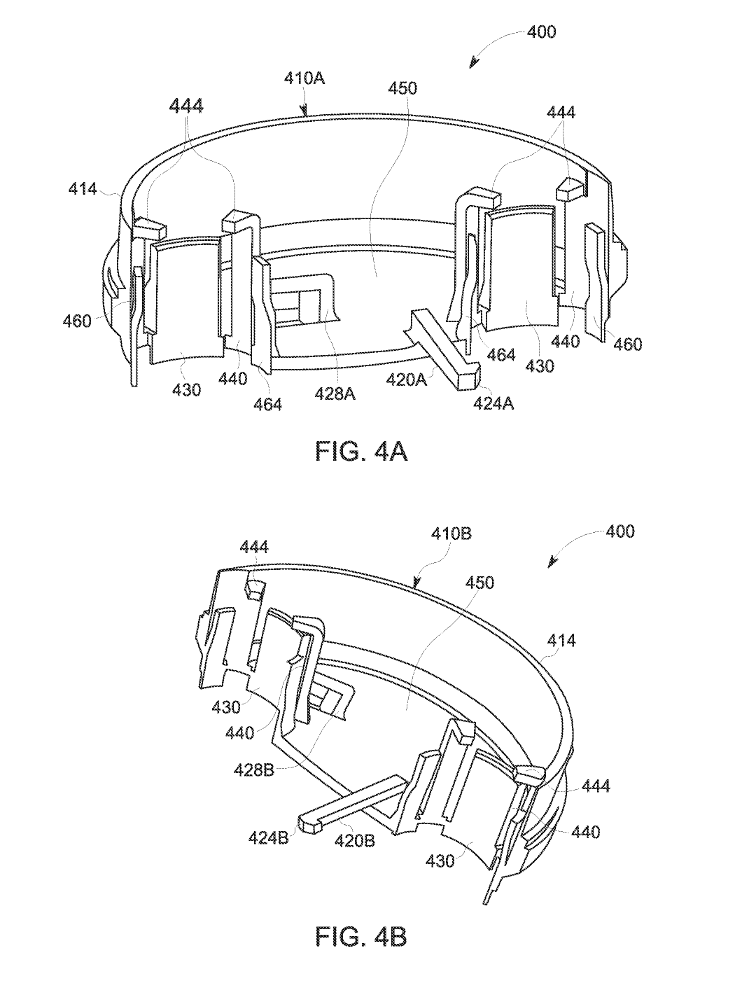

FIGS. 4A-4B depict discharge tube collar 400 which includes two sections 410A, 410B in accordance with some embodiments. Conventional collars are single piece units that have apertures in their base through which ends of the discharge tube are inserted. Conventional collars are joined to the discharge tube by gluing, melting, and/or some other adhesive bonding. In accordance with embodiments, sections 410A, 410B are mated (i.e., joined) together after being positioned around and above the legs of the discharge tube. Embodying discharge tube collar sections are mated together in an adhesive-less manner without the need for gluing, melting, and/or adhesive bonding. When mated together discharge tube collar 400 includes apertures 470 (FIG. 4C).

Each of section 410A, 410B includes arm 420A, 420B which each include pawl 424 (i.e., 424A and 424B) projecting from a distal end of the arm. At a corresponding position on the other section is located frame 428A, 428B. Respective corresponding arms can be inserted through respective corresponding frames to join sections 410A, 410B around the assembled discharge tube to form discharge tube collar 400. Once the arm is inserted into the frames so that pawl passes through the frame, the pawl secures the arm from withdrawing. In accordance with some embodiments, a tab can be formed inside the frame or on the arm. Depressing the tab can force the arm into a position that releases the pawl from contact with the frame.

In some implementations, a surface of the frame can have teeth that engage the pawl to form a ratchet. In such implementations, the pawl need not be inserted through the frame to secure the two sections of the discharge tube collar together.

In accordance with embodiments, discharge tube collar 400 includes lower clamp 430 and upper clamp 440. Each clamp is formed from clamping members located on both sections 410A, 410B. Lower clamp 430 extends from base 450 of the discharge tube collar. In some implementations, lower clamp 430 can have a cross section that complements the cross section of the discharge tube to create an improved fit when clamped together. For example, in some implementations the lower clamp can have an arcuate cross section with a radius that about matches the circumference of the discharge tube. In other implementations, the radius of the lower clamp cross section can be the long axis of an oval, where the short axis of the oval corresponds to about the circumference of the discharge tube. In this implementation, aperture 470 is about a geometric oval in shape. The geometric oval shape can reduce deformation of, and stress against, the discharge tube due to manufacturing tolerances of the discharge tube. Upper clamp 440 extends from base 450 of the discharge tube collar and includes projection 444 at an end distal from the base.

Flexible clamp 460 extends from sidewall 414 of discharge tube collar 400. One end of flexible clamp is in connection with a discharge tube collar section. At an end distal from the connection, flexible clamp 460 is free from the discharge tube collar section. Flexible clamp 464 extends from base 450 at a position opposing the position of flexible clamp 460. Flexible clamp 460, 464 act as springs to apply pressure against a discharge tube when assembled into the discharge tube collar. The pressure is exerted against the discharge tube to position each leg of the discharge tube within a respective aperture 470. Either section 410A, section 410B, or both sections 410A, 410B can include flexible clamps 460, 464.

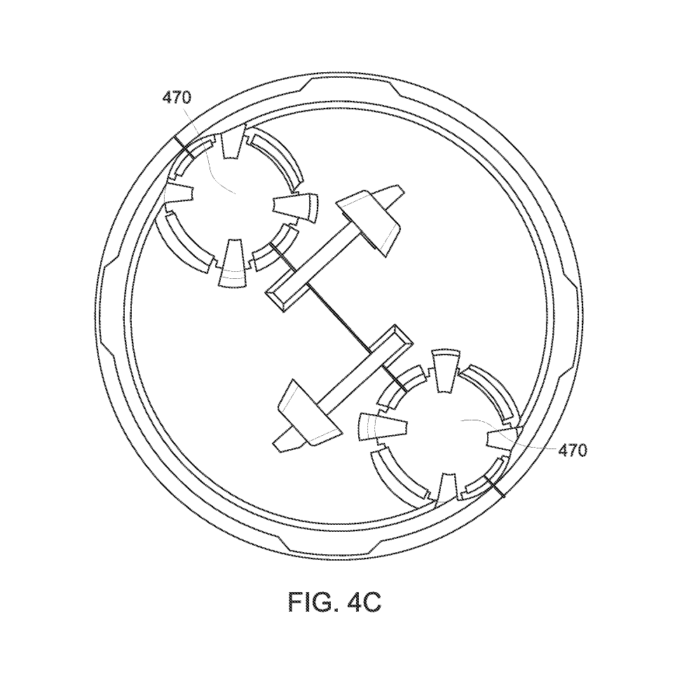

FIG. 5 depicts lamp assembly 500 which includes discharge tube 300 and discharge tube collar 400 in accordance with some embodiments. For illustration purposes, FIG. 5 depicts lamp assembly not yet fully assembled (i.e., sections 410A, 410B are not fully positioned together around the discharge tube legs). As illustrated in FIG. 5, arms 420A, 420B are inserted through respective corresponding frame 428A, 428B. Sections 410A, 410B of the discharge tube collar are joined together and encompassing portions of the discharge tube. Lower clamp members 430 are positioned around each end of the discharge tube. When arm 420A, 420B is fully inserted through respective corresponding frame 428A, 428B, the lower clamp members are compressed to the discharge tube outer surface. Additionally, upper clamp member 440 and lower clamp member 430 are pressed against the distal surface of seal rings 310. Flexible clamps 460, 464 exert pressure against the discharge tube to position each of its legs within the corresponding aperture 470. The pressure against the seal rings from each of these clamping members results in a fixed position of the discharge tube within the apertures of the assembled discharge tube collar.

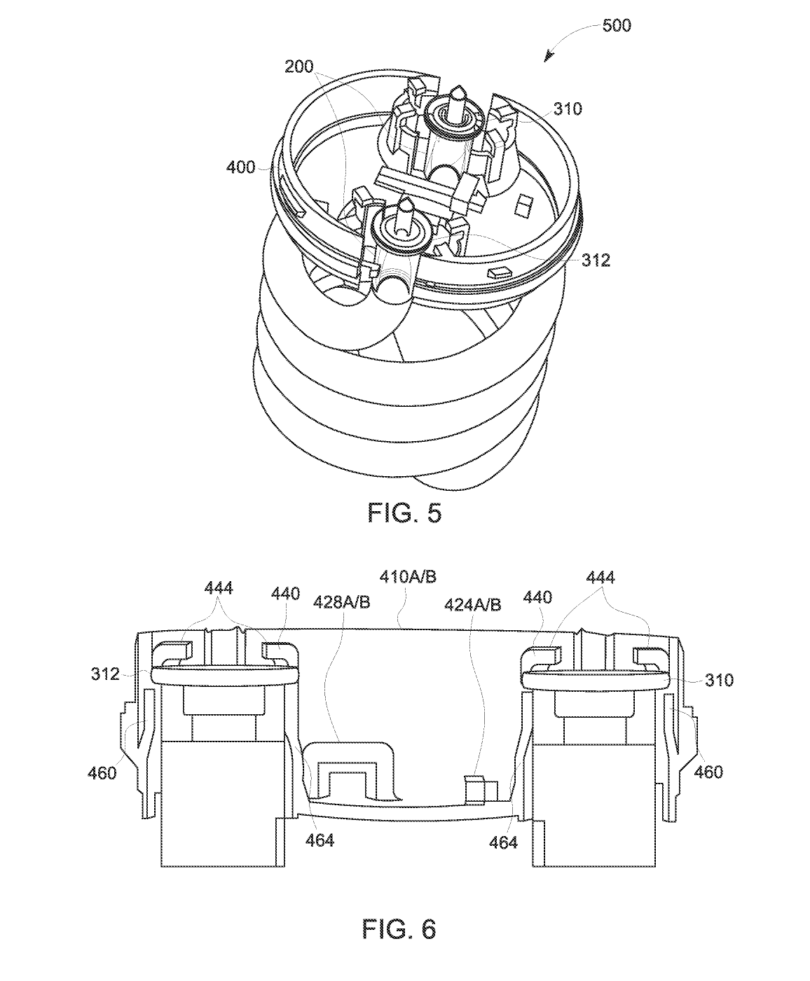

FIG. 6 depicts a partial perspective view of discharge tube assembly 500 in accordance with some embodiments. As disclosed above, the lower clamp of the discharge tube collar is pressed against a portion of the discharge tube to secure the discharge tube and the discharge tube collar together. The upper clamp protrusion is pressed against a distal surface of the seal ring to secure the stem assembly to the discharge tube.

In accordance with embodiments, components of the finished lamp assembly can be combined in an adhesive-less manner—i.e., adhesive-less having the meaning of without any glue, thermal bonding, and/or adhesive.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A collar for assembling a gas discharge tube lighting source, the collar comprising:
at least a first section separate from a second section, the first section and the second section configured to mate together in an adhesive-less manner and form at least one aperture;
each of the first and the second section including a base surface;
an arm extending along an axis about parallel from the base surface of at least one of the first and the second section, the arm including a pawl at an end distal from the base;
a frame on another of the first and the second section, the frame at a position corresponding to the arm;
a lower clamp located on the first and the second section;
an upper clamp located on the first and the second section extending about perpendicular from the base surface, the upper clamp including a projection at an end distal from the base surface;
a first flexible clamp extending from a sidewall of each of the first and the second section; and
a second flexible clamp extending from the base surface, the first flexible clamp and the second flexible clamp at opposing ends of a diameter of the aperture.

2. The collar of claim 1, including the at least one aperture sized to contain an end of a gas discharge tube.

3. The collar of claim 1, including the at least one aperture having about a geometric oval shape having a long and a short axis.

4. The collar of claim 3, including the first flexible clamp and the second flexible clamp at opposing ends of the long axis.

5. The collar of claim 1, including the pawl and the frame configured to interlock together to join the at least first section with the second section in the adhesive-less manner.

6. The collar of claim 5, including a tab located on one of the frame and the pawl, the tab configured to release the pawl from the frame.

7. The collar of claim 2, including the lower clamp having a cross section that complements a cross section of the gas discharge tube.

8. A gas discharge tube lighting assembly comprising:
a discharge tube collar, the discharge tube collar having two portions which mate together in an adhesive-less manner to form an aperture;
a discharge tube having a stem assembly with a first portion and a second portion, the stem assembly first portion sized to fit within the discharge tube and the stem assembly second portion having a flare which forms a seal ring that has a diameter greater than the outer diameter of the discharge tube;
the discharge tube collar and discharge tube connected together by adhesive-less mechanical forces exerted on surfaces of the discharge tube collar and discharge tube, the surfaces including an upper clamp and a lower clamp of the discharge tube collar being in contact with a distal end of the discharge tube and a seal ring;
the discharge tube inserted through the aperture.

9. The gas discharge tube lighting assembly of claim 8, the collar including:
a respective first arm and a respective second arm extending about parallel to a base surface of each of the two portions;
a pawl located at a distal end of each arm;
a respective frame located at a corresponding position to each of the respective first and second arms on the other of the respective collar portion; and
the two portions of the discharge tube collar structured to be joined by inserting one of the respective arms into the corresponding respective frame.

10. The gas discharge tube lighting assembly of claim 9, the collar including a tab located on one of a respective arm and frame, the tab configured to release the arm from the frame.

11. The gas discharge tube lighting assembly of claim 9, including a surface of each respective frame having teeth that engage the pawl on the arm to form a ratchet to secure the two collar portions together.

12. The gas discharge tube lighting assembly of claim 9, including:
a first flexible clamp extending from a sidewall of the collar;
a second flexible clamp extending from a base surface of the collar, the first flexible clamp and the second flexible clamp located at opposing ends of an axis of the aperture.

13. The gas discharge tube lighting assembly of claim 8, the lower clamp having a cross section that complements the cross section of the discharge tube.

14. The gas discharge tube lighting assembly of claim 8, the upper clamp having a projection at an end distal from a base of the collar, the discharge tube positioned within the aperture so that the seal ring is against a lower surface of the projection.

15. The gas discharge tube lighting assembly of claim 8, the aperture having about a geometric oval shape.
